(19) United States
(12) Patent Application Publication
(10) Pub. No.: US 2023/0297726 A1
(43) Pub. Date: Sep. 21, 2023

(54) EXPANSION (E)-PORT SPOOFING DETECTION AND COUNTERMEASURES

(71) Applicant: DELL PRODUCTS L.P., Round Rock, TX (US)

(72) Inventors: Erik SMITH, Douglas, MA (US); Azzam TANOUS, Cambridge, MA (US)

(73) Assignee: DELL PRODUCTS L.P., Round Rock, TX (US)

(21) Appl. No.: 17/697,793

(22) Filed: Mar. 17, 2022

(51) Int. Cl. G06F 21/85; G06F 13/40

(52) U.S. Cl. CPC G06F 21/85; G06F 13/4022; G06F 2213/0008

(57) ABSTRACT

Systems and methods for detecting cybersecurity attacks comprise monitoring switches in a Fibre Channel (FC) fabric to obtain and examine network information to identify indicators of compromise (IoC), such as an attempt of a compromise or an actual compromise of the FC fabric by an unauthorized device. Exemplary IoCs comprise changes in zoning and/or the number of switches in the fabric.

### BACKGROUND

### A. Technical Field

The present disclosure relates generally to information handling systems. More particularly, the present disclosure relates to thwarting cybersecurity attacks, such as E-port spoofing, to increase computer network security.

### B. Background

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Storage area network (SAN) systems are high-value assets for enterprises and a prime target for cybersecurity attacks executed by state and non-state actors. E-port spoofing is a type of cybersecurity attack that allows an attacker to break into a SAN system by circumventing fabric zoning with Fibre Channel (FC) SAN policies that are otherwise enforced by the fabric. The attack involves connecting an unauthorized port masquerading as a switch to an unused interface on an FC switch. This enables the motivated attacker to silently bypass FC zoning policies and use the host to gain access to the SAN, e.g., to compromise data, including configuration information residing within the SAN, place malicious backdoor programs to steal data, and the like. Accordingly, it is highly desirable to find ways to reduce the vulnerabilities of FC fabrics and thwart a wide range of cybersecurity attacks, such as E-port spoofing, to increase security in computer networks such as SANs.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1A shows a common FC fabric setup.

FIG. 1B shows a compromised FC environment.

FIG. 2 is a pictorial view of an exemplary chain of IoC events.

FIG. 3 depicts various steps of a fabric configuration process according to the FC-SW protocol.

FIG. 4 illustrates how a rogue switch progresses from exchange fabric parameters (EFP) to build fabric (BF).

FIG. 5 depicts a flowchart for intrusion detection method for detecting cybersecurity attacks, according to embodiments of the present disclosure.

FIG. 6 depicts a simplified block diagram of an information handling system, according to embodiments of the present disclosure.

FIG. 7 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to a system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks, and the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.”

Any headings used herein are for organizational purposes only and shall not be used to limit the scope of the description or the claims. Each reference/document mentioned in this patent document is incorporated by reference herein in its entirety.

It shall be noted that although embodiments described herein may be within the context of E-port spoofing intrusion detection in SANs, aspects of the present disclosure are not so limited. Accordingly, the aspects of the present disclosure may be applied or adapted to protect against a wide range of cybersecurity attacks in other computer networks.

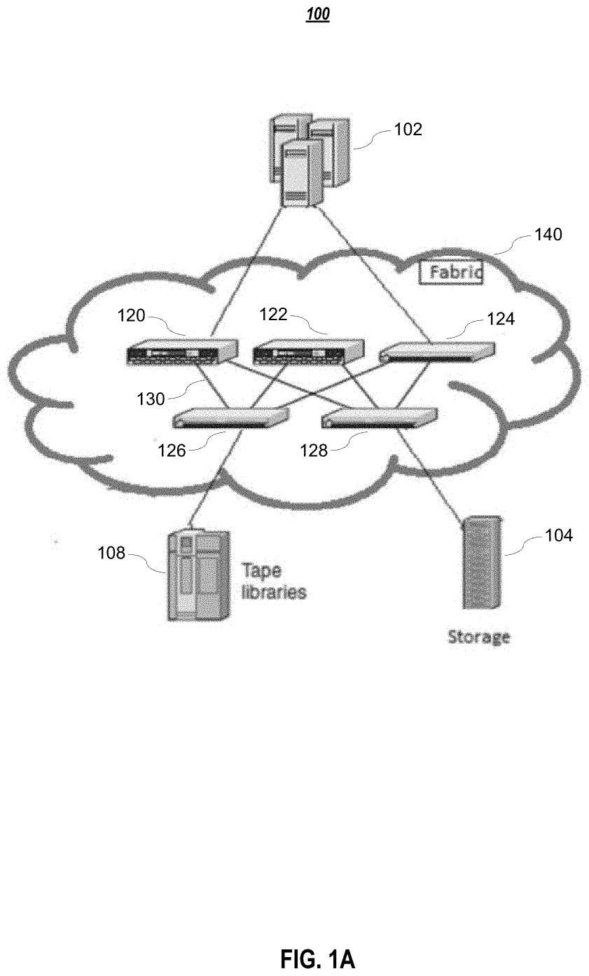

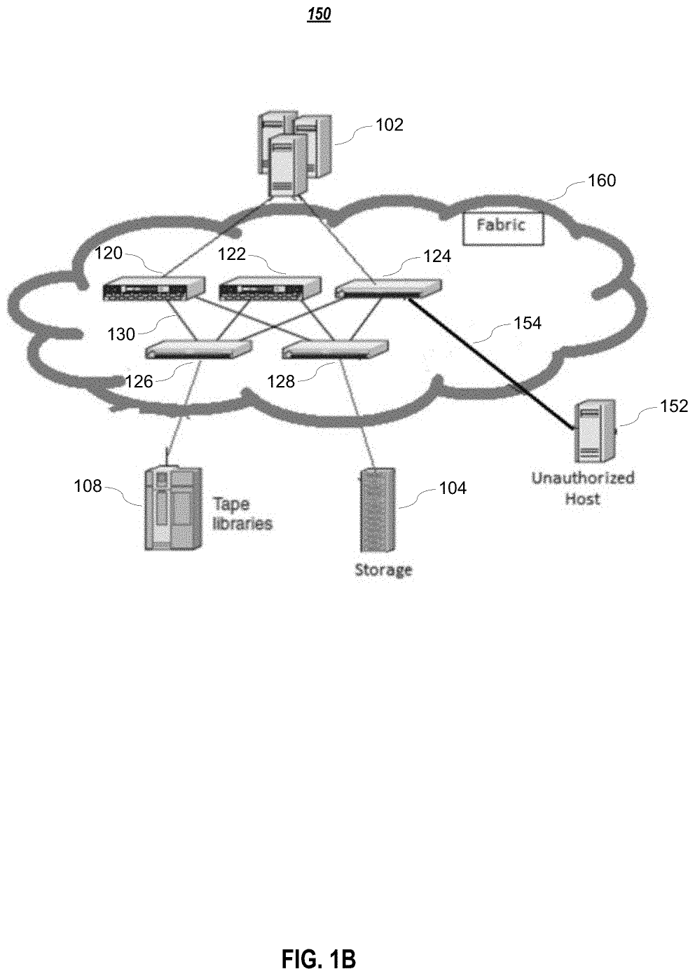

Cybersecurity attacks take many shapes and forms. E-port spoofing is one type of impersonation attack that exploits a useful feature of FC fabrics that makes FC fabrics easy to form and expand: allowing switches to automatically join a fabric without manual intervention. FIG. 1A and FIG. 1B compare a typical FC fabric environment with a compromised FC fabric environment. Compromised fabric 160 in compromised FC fabric environment 160 in FIG. 1B is similar to fabric 140 with the exception that fabric 160 further comprises connection 154 between switch 124 and unauthorized host 152.

A typical FC fabric such as fabric 140 in FIG. 1A comprises a number of switches 120-128 that are interconnected via Inter-Switch Links (ISLs) (e.g., 130) to exchange data and management traffic. As depicted, switches 120-128 in fabric 140 are used to route data from host 102 to storage 104 or tape libraries 108. Typically, switches 120-128 connect to each other via E-ports and use F-ports to connect to N-ports of end devices, e.g., storage 104 and host 102, to enable such end devices to connect to fabric 140.

Generally, the determination of whether an FC switch 120-128 initializes as an E-port or as an F-port when connecting to the N-port of the end device is based on a negotiation that follows a protocol. By default, an FC switch port may be configured as a generic port (Gx_PORT) or a universal port (U_Port), depending on the device that connects to that port. In the case of a switch connecting to another switch, the switches transmit exchange link parameter (ELP) frames between their ports. In the case of storage device 104 or host 102 connecting to fabric 140, that device sends a fabric login (FLOGI) to register itself with fabric 140 and inquires about which ports of the switch the device is permitted to access. The accessibility of ports for a given device is determined by FC zoning rules. Zoning is the process of assigning a host-storage pair to a zone in which the pair is permitted to communicate. Conversely, entities that are not members of the zone are not permitted to communicate with the zone members.

Notwithstanding zoning rules, nothing prevents an unauthorized host, such as host 152 in FIG. 1B, from sending out an ELP frame to any of FC switch 120-128 and pose as an E-port of an FC switch that is attempting to initialize and connect to fabric 160. This presents a vulnerability that an attacker may exploit to attach unauthorized host 152, such as a rogue FC switch or a host bus adapter (HBA) that has been modified to impersonate a switch port, to a Gx_PORT or U_Port to mount an attack. This may be accomplished, e.g., by utilizing an unused interface of FC switch 124 to participate in a negotiation protocol using a brute-force method to become a member of fabric 160. This enables a motivated attacker to use unauthorized host 102 to gain access to FC fabric 160 and bypass FC zoning policies, e.g., to manipulate data, including configuration information residing in the SAN.

As an example, once unauthorized host 152 has been attached to switch 124 and obtains configuration information about fabric 160, unauthorized host 152 could modify the obtained information. If successful, unauthorized host 152 may impose the modified information onto fabric 160. Further, unauthorized host 152 may directly access individual ports in fabric 160, e.g., to connect to and manipulate any target in storage resource 104 in compromised fabric 160. The attacker may use software (e.g., solutions enabler) to modify the array's LUN/namespace masking definition and grant unauthorized host 152 access to any LUNs/namespaces available on that storage interface. The attacker may then detach unauthorized host 152 from fabric 160 (and/or the HBA impersonating the switch), and restore the original zoning configuration to cover traces of improper activity such that these remain undetected for an extended period time. Such undetected attacks can cause significant harm to the targeted enterprise or organization. Therefore, it is desirable to have effective intrusion detection systems and methods that counter APTs and related cybersecurity attacks in computer networks.

One or more embodiments herein utilize intrusion detection systems and methods that analyze network-related data to identify indicators of compromise (IoC) to counter E-port spoofing and similar security vulnerabilities. In one or more embodiments, switch (e.g., 120) or a user may gather, e.g., at the user interface of the switch in fabric 140 or centrally in fabric 140, information regarding any number of switches 120-128. Suitable information comprises any network-related information, such as a change in the number of switches in fabric 140, switches associated with a change in zoning, ISL segmentations, link reset events, or any combination thereof, including timing and order information.

In one or more embodiments network-related information may be obtained as part of an ELP process that involves exchanging ELP frames comprising parameters that are required to match, e.g., a unique domain ID or the same type of values. It is understood that any other type of information in any arbitrary format may be used to identify IoCs. In one or more embodiments, the gathered information is examined to detect one or more indicators of an attempt by a rogue device, such as unauthorized host 152 that acts as a switch, to access or compromise fabric 140.

In one or more embodiments, once a switch (e.g., 124) gathers or obtains the fabric-related information and detects certain symptoms, such as parameters that conflict or are incompatible with sending rogue “switch” 152 that would cause link 154 to fail, the receiving switch 124 may send an error code to switch 152 that sent the incompatible parameter. The incompatibility will cause an ISL segmentation that isolates switch 152 from fabric 160 and prevent certain protocols from being exchanged over link 154 between those switches, e.g., until rogue switch 152 initiates a link reset to restart link initialization, e.g., by sending an ELP frame with different parameters. If the new parameters exhibit no incompatibility, the switches may resume, e.g., with an ESC process, according to the Fibre Channel Standard FC-SW protocol (hereinafter, “FC-SW protocol”).

Exemplary IoC events useful in detecting an intrusion or an attempt of intrusion or compromise of fabric 160 by unauthorized device 152 may comprise any combination of repeated ISL segmentations and an increase and/or decrease in the number of switches or domains in fabric 160. As an example, a repeated ISL segmentation caused by incompatibility between switch 124 and rogue switch 152 may be followed by a successful connection leading to an increase in the number of switches, namely switch 152, in fabric 160, followed by a change in zoning. Similarly, in scenarios where unauthorized host 152 is successful in connecting to switch 124 at the first attempt, there would still be an observable increase (and subsequent decrease) in the number of switches in fabric 160 that is tracked due to the fact that fabric 160 tracks how many domains are available. Thus, in one or more embodiments, where unauthorized device 152 uses correct parameters at the first try such that no ISL segmentation is triggered, suitable IoC events comprise (1) an increase in the number of switches in fabric 160, followed by (2) a change in zoning, followed by (3) a decrease in the number of switches in fabric 160. It is understood that a change in the number of switches may be ascertained by using any metric known in the art, including a change in the number of ISLs or any other set of parameters. It is further understood that such metrics may be determined directly or indirectly.

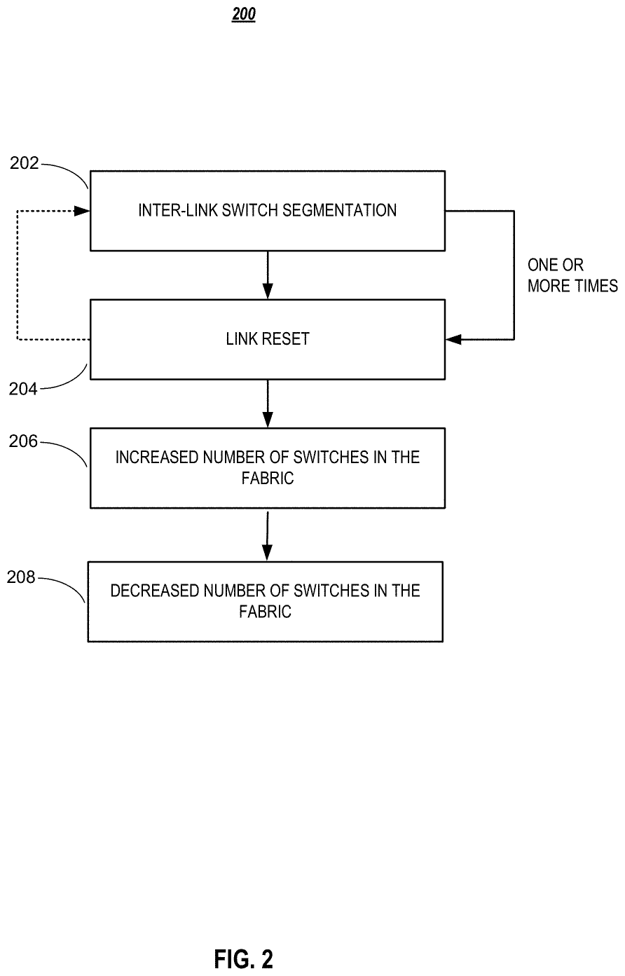

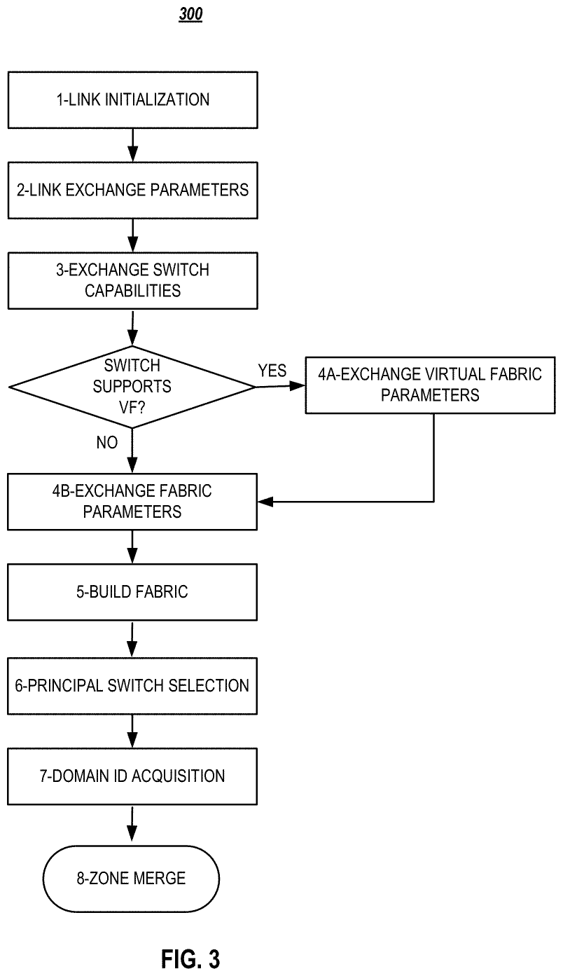

FIG. 2 is a pictorial view of an exemplary chain of IoC events. The IoC events for this attack comprise ISL segmentation 202 that, as mentioned, may be caused by conflicting or incompatible parameters between an FC switch in an FC fabric and a rogue device, such as a host physically connected to the switch that impersonates an E-port of an FC switch in an attempt to become a member of the fabric. In one or more embodiments, after an unsuccessful attempt and ISL segmentation 202, the rogue device may initiate a link reset 204 to renew its attempt to join the fabric. It is understood that the rogue device may make any number of such attempts, e.g., by using the FC-SW protocol that specifies four phases for a fabric merge process: (1) switch port initialization; (2) principal switch selection; (3) assign domain ID; and (4) fabric shortest path first (FSPF) distribution, shown in a more granular fashion in FIG. 3 below. In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); and (5) an acceptable outcome has been reached.

Once the rogue device succeeds in connecting to the fabric, this connection will increase 206 the switch count in the fabric, and the rogue device may launch its attack to effectuate a change in zoning (not shown in FIG. 2). In one or more embodiments, the rogue device may then detach from the port of the switch to reduce the likelihood of an administrator discovering the security breach. Since, by default, fabric configuration changes do not trigger an alarm in operational frameworks, detection of an advanced persistent threat (APT) or attack by a storage administrator remains improbable for extended periods of time. Detaching the rogue device from the switch will cause the switch count in the fabric to decrease 208.

In one or more embodiments, a set of indicators of potential spoofing may be used to detect a specific pattern that is indicative of a security breach to trigger one or more alarms. Exemplary alarms comprise generating and communicating a notification to an administrator, disabling certain services, restricting account access, initiating a diagnostic, and the like. It is understood that any monitoring tool known in the art may be used to detect indicia of unauthorized access to a fabric, including real-time monitoring tools. By monitoring a relatively small number of indicators, the monitoring effort may be kept advantageously low. However, this is not intended as a limitation on the scope of the disclosure. As a person of skill in the art will appreciate, any combination indicative of unauthorized access or compromise of fabric 160, or any attempted unauthorized access or compromise of fabric 160, may be used to trigger an alarm and/or countermeasure.

FIG. 3 depicts various steps of a fabric configuration process according to the FC-SW protocol. It is noted that no path selection and egress port assignment steps are shown as these are less relevant to detecting IoC events. Fabric configuration process 300 in FIG. 3 includes (1) link initialization; (2) exchange link parameters (ELP); (3) exchange switch capabilities (ESC), followed by a determination of whether a switch supports virtual fabric (VF); (4a) exchange virtual fabric parameters (EVFP); (4b) exchange fabric parameters (EFP); (5) exchange fabric parameters (EFP); build fabric (BF); (6) principal switch selection; (7) domain ID acquisition; and (8) zone merge.

It is noted that an ISL segmentation may occur at any point in fabric configuration process 300, i.e., for any number of reasons. For example, if a rogue switch already has a fabric definition, it may be compared to an existing fabric definition, and incompatible zoning configurations may trigger an ISL segmentation. To complete all eight steps depicted in FIG. 3, a rogue switch must match the capabilities and configuration parameters of the switch in the fabric that that rogue switch is attempting to connect to. Therefore, an incompatibility at any of steps 1-8 may cause an ISL segmentation. The most common causes of ISL segmentation include (1) a segment not being defined; (2) incompatible operating parameters, such as resource allocation time out value (R_A_TOV); error detect time out value (E_D_TOV); interop mode; data field size; sequence level switching; disable Class F traffic; per frame route priority; and long-distance fabric; (3) duplicate domain ID(s); (4) incompatible zoning configurations; (5) build fabric protocol error; (6) no principal switch; (7) no response from an attached switch; and (8) ELP retransmission failure. One possible way that a rogue switch can overcome a compatibility hurdle is to adopt the same capabilities as the switch that it is attempting to connect to after an ISL segmentation and a link reset that restarts the switch port initialization according to the FC-SW protocol, previously mentioned with regard to FIG. 2.

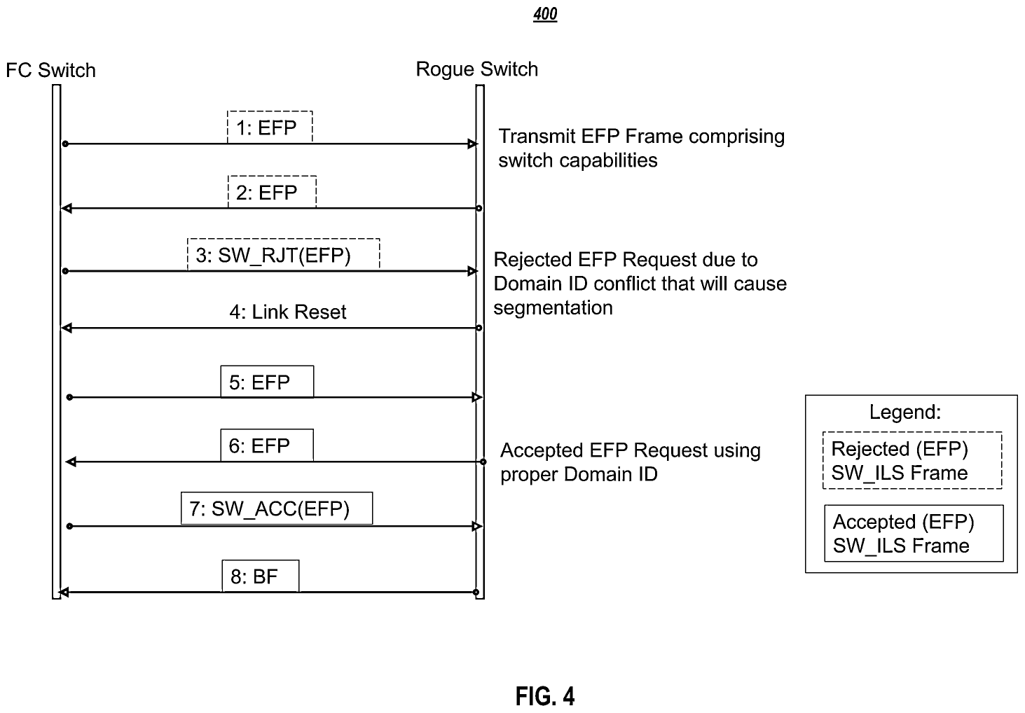

FIG. 4 illustrates how a rogue switch progresses from transmitting exchange fabric parameters to Build Fabric (BF) according to the FC-SW protocol. The acceptance of an EFP by a switch within an FC fabric is predicated upon the absence of a domain ID conflict or overlap. A rogue switch may overcome such domain ID overlap by selecting a domain ID and attempting to bring the link up again, until a proper domain ID that causes no domain ID overlap is found. The rogue switch may then transmit a proper EFP request to the FC switch, which will accept the request and respond with an EFP acceptance SW_ILS frame. Once the rogue switch becomes a participating member of the fabric, the entirety of the SAN environment will be compromised. It is noted that a rogue switch may use this or any other approach to overcome similar compatibility issues that it may encounter at any step of the fabric configuration process in FIG. 3.

Once the zone merge step in the fabric configuration process 300 in FIG. 3 is complete, the number of switches participating in the fabric will briefly increase, and the zone definitions will be updated to reflect a change in zoning configuration. Then, once the rogue switch detaches from the fabric, the number of switches will return to its previous count. In one or more embodiments, a change in the number of switches in the fabric may be used as an indicator of a potential attack (i.e., an IoC) on an FC network (e.g., an E-port spoofing attack), as previously mentioned.

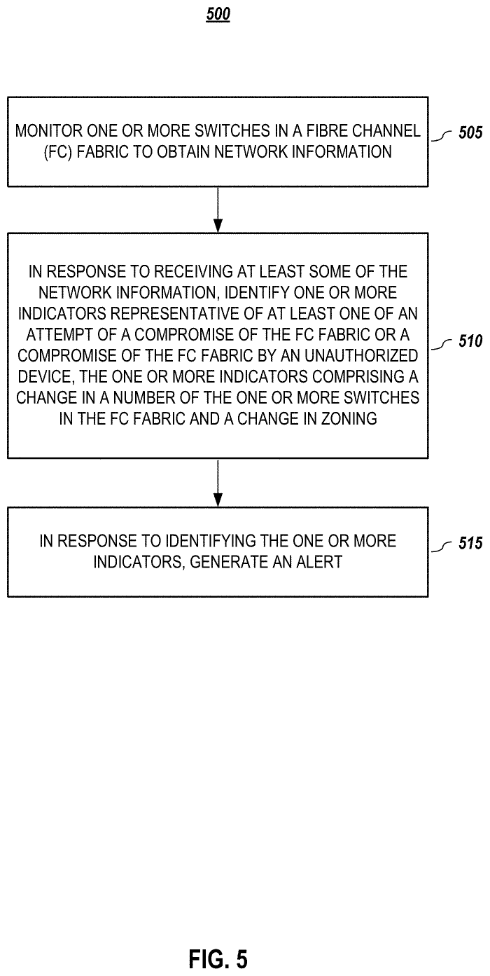

FIG. 5 depicts a flowchart for intrusion detection method for detecting cybersecurity attacks, according to embodiments of the present disclosure. In one or more embodiments, intrusion detection method may commence, when an authorized device monitors (505) one or more switches in an FC fabric (e.g., within a SAN) to gather information that may comprise any kind of network information. In one or more embodiments, the authorized device may gather and/or analyze information remotely, e.g., by gathering the information from a switch that monitors switches in the fabric. Analysis may comprise a predictive analysis method that evaluates a risk level for the SAN. In particular, the information may be examined to identify (510) one or more indicators of an attempt of an unauthorized access or compromise of the FC fabric or an actual unauthorized access or compromise, such as an E-port spoofing attempt by an unauthorized host or host bus adapter that acts as a switch. Indicators may comprise a change in the number of switches, e.g., an increase followed by a decrease in number, a change in zoning, one or more ISL segmentations, link resettings, and the like. In one or more embodiments, indicators may be used to predict the risk of a security breach of the FC fabric, and a risk score maybe generated.

In one or more embodiments, once one or more indicators have been detected, an alert may be generated (515) and communicated to a user to initiate an appropriate action to thwart a cybersecurity attack. It shall be noted that: (1) certain steps may optionally be performed; (2) steps may not be limited to the specific order set forth herein; (3) certain steps may be performed in different orders; and (4) certain steps may be done concurrently.

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read-only memory (ROM), and/or other types of memory. Additional components of the computing system may include one or more drives (e.g., hard disk drives, solid-state drive, or both), one or more network ports for communicating with external devices as well as various input and output (I/O) devices. The computing system may also include one or more buses operable to transmit communications between the various hardware components.

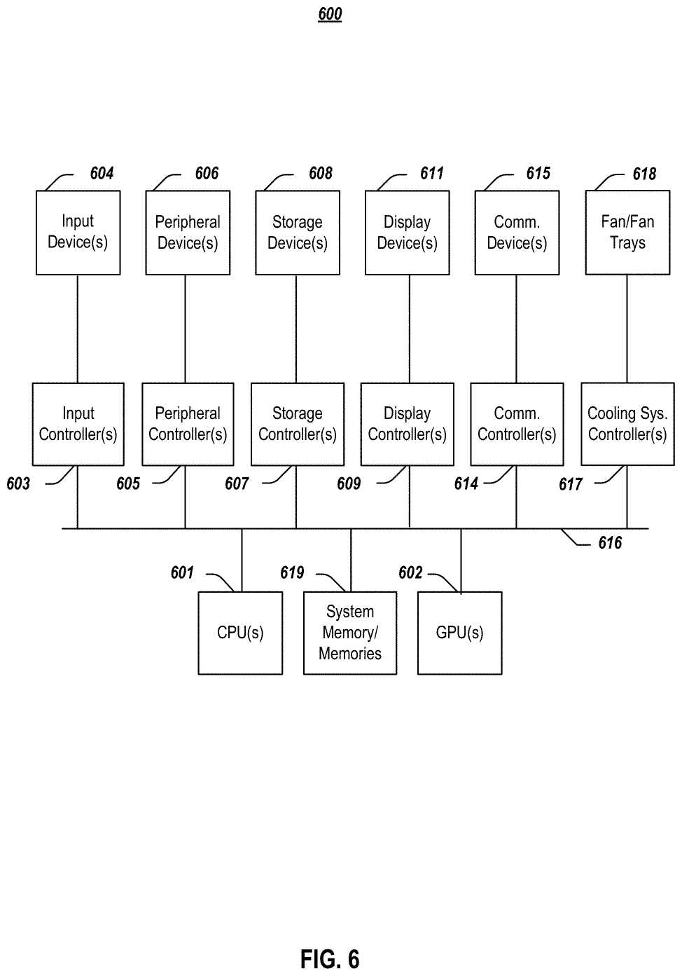

FIG. 6 depicts a simplified block diagram of an information handling system (or computing system), according to embodiments of the present disclosure. It will be understood that the functionalities shown for system 600 may operate to support various embodiments of a computing system—although it shall be understood that a computing system may be differently configured and include different components, including having fewer or more components as depicted in FIG. 6.

As illustrated in FIG. 6, the computing system 600 includes one or more CPUs 601 that provide computing resources and control the computer. CPU 601 may be implemented with a microprocessor or the like and may also include one or more graphics processing units (GPU) 602 and/or a floating-point coprocessor for mathematical computations. In one or more embodiments, one or more GPUs 602 may be incorporated within the display controller 609, such as part of a graphics card or cards. The system 600 may also include a system memory 619, which may comprise RAM, ROM, or both.

A number of controllers and peripheral devices may also be provided, as shown in FIG. 6. An input controller 603 represents an interface to various input device(s) 604, such as a keyboard, mouse, touchscreen, stylus, microphone, camera, trackpad, display, etc. The computing system 600 may also include a storage controller 607 for interfacing with one or more storage devices 608 each of which includes a storage medium such as magnetic tape or disk, or an optical medium that might be used to record programs of instructions for operating systems, utilities, and applications, which may include embodiments of programs that implement various aspects of the present disclosure. Storage device(s) 608 may also be used to store processed data or data to be processed in accordance with the disclosure. The system 600 may also include a display controller 609 for providing an interface to a display device 611, which may be a cathode ray tube (CRT) display, a thin film transistor (TFT) display, organic light-emitting diode, electroluminescent panel, plasma panel, or any other type of display. The computing system 600 may also include one or more peripheral controllers or interfaces 605 for one or more peripherals 606. Examples of peripherals may include one or more printers, scanners, input devices, output devices, sensors, and the like. A communications controller 614 may interface with one or more communication devices 615, which enables the system 600 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a SAN or through any suitable electromagnetic carrier signals including infrared signals. As shown in the depicted embodiment, the computing system 600 comprises one or more fans or fan trays 618 and a cooling subsystem controller or controllers 617 that monitors thermal temperature(s) of the system 600 (or components thereof) and operates the fans/fan trays 618 to help regulate the temperature.

In the illustrated system, all major system components may connect to a bus 616, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

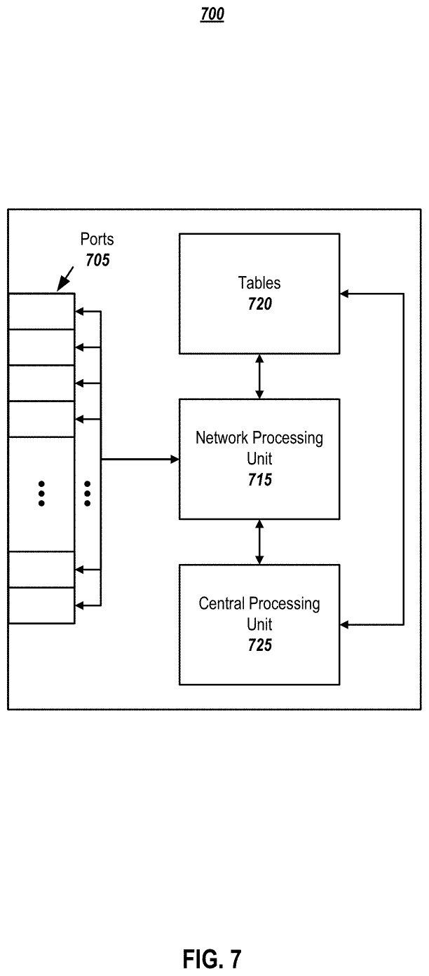

FIG. 7 depicts an alternative block diagram of an information handling system, according to embodiments of the present disclosure. It will be understood that the functionalities shown for system 700 may operate to support various embodiments of the present disclosure—although it shall be understood that such system may be differently configured and include different components, additional components, or fewer components.

The information handling system 700 may include a plurality of I/O ports 705, a network processing unit (NPU) 715, one or more tables 720, and a CPU 725. The system includes a power supply (not shown) and may also include other components, which are not shown for sake of simplicity.

In one or more embodiments, the I/O ports 705 may be connected via one or more cables to one or more other network devices or clients. The network processing unit 715 may use information included in the network data received at the node 700, as well as information stored in the tables 720, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher-level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented intrusion detection method for identifying cybersecurity attacks, the method comprising:
monitoring one or more switches in a Fibre Channel (FC) fabric to obtain network information;
in response to receiving at least some of the network information, identifying one or more indicators representative of at least one of an attempt of a compromise of the FC fabric or a compromise of the FC fabric by an unauthorized device, the one or more indicators comprising a change in a number of the one or more switches in the FC fabric and a change in zoning; and
in response to identifying the one or more indicators, generating an alert.

2. The computer-implemented method of claim 1 further comprising:
detecting one or more ISL segmentations and one or more link resettings that follow the change in the number of the one or more switches and the change in zoning.

3. The computer-implemented method of claim 1 wherein the unauthorized device is at least one of an unauthorized host that acts as a switch or a host bus adapter that acts as a switch.

4. The computer-implemented method of claim 1 wherein the step of monitoring is performed by a switch in the FC fabric.

5. The computer-implemented method of claim 1 wherein the step of examining the network information comprises using a remotely located device that uses the one or more indicators to predict a risk of a security breach of the FC fabric.

6. The computer-implemented method of claim 5 wherein the security breach comprises E-port spoofing.

7. The computer-implemented method of claim 1 wherein generating the alert comprises generating a notification and communicating the notification to a user.

8. The computer-implemented method of claim 7 wherein the notification comprises a risk score.

9. A non-transitory computer-readable medium or media comprising one or more sequences of instructions which, when executed by at least one processor, causes steps to be performed comprising:
receiving network information regarding one or more switches in a Fibre Channel (FC) fabric;
in response to receiving at least some of the network information, identifying one or more indicators representative of at least one of an attempt of a compromise of the FC fabric or a compromise of the FC fabric by an unauthorized device, the one or more indicators comprising a change in a number of the one or more switches in the FC fabric and a change in zoning; and
in response to identifying the one or more indicators, generating an alert.

10. The non-transitory computer-readable medium or media of claim 9 further comprising, detecting one or more ISL segmentations and one or more link resettings that follow the change in the number of the one or more switches and the change in zoning.

11. The non-transitory computer-readable medium or media of claim 9 wherein the unauthorized device is at least one of an unauthorized host that acts as a switch or a host bus adapter that acts as a switch.

12. The non-transitory computer-readable medium or media of claim 9 wherein the step of monitoring is performed by a switch in the FC fabric.

13. The non-transitory computer-readable medium or media of claim 9 wherein the step of examining the network information comprises using a remotely located device that uses the one or more indicators to predict a risk of a security breach of the FC fabric.

14. The non-transitory computer-readable medium or media of claim 13 wherein the security breach comprises E-port spoofing.

15. The non-transitory computer-readable medium or media of claim 9 wherein generating the alert comprises generating a notification and communicating the notification to a user.

16. The non-transitory computer-readable medium or media of claim 15 wherein the notification comprises a risk score.

17. A system for identifying cybersecurity attacks, the system comprising:
one or more processors; and
a non-transitory computer-readable medium or media comprising one or more sets of instructions which, when executed by at least one of the one or more processors, causes steps to be performed comprising:
receiving network information regarding one or more switches in a Fibre Channel (FC) fabric;
in response to receiving at least some of the network information, identifying one or more indicators representative of at least one of an attempt of a compromise of the FC fabric or a compromise of the FC fabric by an unauthorized device, the one or more indicators comprising a change in a number of the one or more switches in the FC fabric and a change in zoning; and
in response to identifying the one or more indicators, generating an alert.

18. The system of claim 17 further comprising detecting one or more ISL segmentations and one or more link resettings that follow the change in the number of the one or more switches and the change in zoning.

19. The system of claim 17 wherein the non-transitory computer-readable medium or media further comprises one or more sets of instructions which, when executed by at least one of the one or more processors, causes steps to be performed comprising using the one or more indicators to predict a risk of a security breach of the FC fabric.

20. The system of claim 19 wherein the security breach comprises E-port spoofing.
